(19) United States
(12) Patent Application Publication
(10) Pub. No.: US 2016/0120758 A1
(43) Pub. Date: May 5, 2016

(54) SMART PILL CONTAINER, CONTROL METHOD AND SYSTEM

(71) Applicants: Bo PI, San Diego, CA (US); Halton PI, San Diego, CA (US)

(72) Inventors: Bo PI, San Diego, CA (US); Halton PI, San Diego, CA (US)

(21) Appl. No.: 14/933,884

(22) Filed: Nov. 5, 2015

Related U.S. Application Data
(60) Provisional application No. 62/075,804, filed on Nov. 5, 2014.

(51) Int. Cl. A61J 7/04; H04Q 9/00; A61J 1/03

(52) U.S. Cl. CPC A61J 7/04; A61J 1/03; H04Q 9/00; H04Q 2209/40

(57) ABSTRACT

A medicine pill box or pill bottle equipped with sensors to detect presence or absence status of pills and/or movement of the pill box or bottle and/or removal of a bottle cap, and a communication module for wirelessly communicating with an external device to exchange data with the connected device and internet-based services. The internet-based service records the data from the pill box or bottle and sends relevant notifications and reminders to authorized users. In one example, capacitive sensors are provided at the bottom of each cell of a pill box having multiple cells, to detect the presence and absence of pills in the cells. In another example, magnetic field sensors are provided on the cap of a pill bottle and magnetic materials are provides on the body of the bottle, to detect the removal of the cap.

### BACKGROUND OF THE INVENTION

1. Field of the Invention

This invention relates to a control system and method to control taking of medicine pills, which uses sensors for monitoring the status of the pill container, and a wireless link to report to user and a server program the status of the pill box to trigger appropriate actions.

2. Description of Related Art

In a conventional pill box, shown in FIG. 5, the pill box has multiple cells, which the user uses to help organize daily medicine or medicine needs to be taken at different times. With a conventional pill box, the user puts one or multiple types of medicines he needs to take each day in each cell of the pill box. And the user will typically remember to take the pill each day. For example, if the user forgot to take the pill for Tuesday, he returns home, and takes a look at the pill box, he will find the pill still in the Tuesday cell. So it also serves as a reminder for the user. However, if the user forgot to check, then he would not know if he took the pill or not. Further, if the user's medicine needs to be taken at certain times, like in the morning, and if user forgot to take it, no one will remind him until he remembers to check the pill box. The user may take the pill at a later time; this delay may affect the medicine effectiveness.

### SUMMARY

One embodiment of this invention relates to a medicine pill box and a related user notification system. The smart pill box has sensors in each pill box cell, and these sensors detect the status of each pill box cells, e.g. the presence or absence of pills, and/or the number of pills in the cell. The smart pill box also has a communication module, which can be wirelessly connected to a communication device, to exchange data with the connected device and also exchange data with an Internet-based service through the connected device. The Internet-based service records the status of each smart pill box, and also provides services like sending notifications to authorized users regarding the status of the pill box, sending out reminders to a mobile device of the smart pill box user to remind the person to take medicine if the medicines in the pill box cell are not taken out in time, etc.

The pill box according to an embodiment of the present invention has a sensor system, which senses the content of each pill box cell, to determine which cell has pills or not. An electronic controller controls the sensor system, and also reads out sensed data from the sensor system. In one embodiment, when a cell contains one or more pills and the user takes out the pill from a cell, the status of the cell is changed from full to empty. This information is sent to the connected communication device, which directly notifies the user, or through the internet-based service sends the notification to multiple peoples who are authorized to receive this information. An internet host database keeps a record of the status of each user. The summery results are updated periodically for authorized persons to view. The authorized persons may include the user himself/herself, the user's care takers, the user's doctors, the user's relatives etc.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a smart pill box system which includes: a pill box body with multiple cell for containing pills; a sensor on the bottom of each cell for detecting presence or absence of the pills in the cell; a sensor circuit for processing signals from the sensor; a communication circuit for wireless communication with external devices; a battery; and a microprocessor unit and memory for controlling operations of the sensor circuit and communication circuit.

In another aspect, the present invention provides a method for monitoring the status of a smart pill box, the smart pill box comprising one or more cells for containing pills, a sensor system for detecting presence or absence status of pills in each cell, control circuitry, and a communication unit, the method including: detecting the presence of absence status of each cell using the sensor system; recording status information for each cell using the control circuitry; and communicating the status information wirelessly to an external data processing system using the communication unit.

In another aspect, the present invention provides a smart pill bottle system which includes: a sensor unit on the bottle, which includes an accelerometer, a magnetic field sensor, a communication circuit, a battery and a microcontroller and memory; and a magnetic material placed on the bottle, wherein the sensor unit is located on a cap of the bottle and the magnetic material is located on a body of the bottle, or the sensor unit is located on the body of the bottle and the magnetic material is located on the cap of the bottle.

In another aspect, the present invention provides a method for monitoring a smart pill bottle, the smart pill bottle including a sensor unit which includes an accelerometer, a magnetic field sensor, a communication circuit, a battery and a Microcontroller and memory, and magnetic material, wherein the sensor unit is located on a cap of the bottle and the magnetic material is located on a body of the bottle, or the sensor unit is located on the body of the bottle and the magnetic material is located on the cap of the bottle, the method including: detecting a motion of the pill bottle using the accelerometer and generating a wakeup signal for the microcontroller;

detecting an event of a separation of the cap and the body of the bottle using the magnetic field sensor and the magnetic material and recording the separation event; and communicating the separation event to an external device.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram showing a smart pill box connected to an internet-based service and to a user according to an embodiment of the present invention.

FIG. 2 is a schematic illustration of the smart pill box according to an embodiment of the present invention.

FIG. 3A shows an exemplary implementation of a capacitive smart pill box sensor design according to an embodiment of the present invention.

FIG. 3B is a schematic illustration of how the capacitive smart pill box sensor of FIG. 3A senses the pills in the box cell.

FIGS. 4A and 4B are flow diagrams showing how the smart pill box operates according to an embodiment of the present invention.

FIG. 5 illustrate a conventional pill box.

FIG. 6 is a schematic illustration of a smart bottle cap sensor according to another embodiment of the present invention.

FIG. 7 is a schematic block diagram of an exemplary implementation of the smart bottle cap sensor design of FIG. 6.

FIG. 8 is a flow diagram showing how the smart cap sensor of FIGS. 6 and 7 operates.

FIGS. 9A and 9B are schematic illustrations of a smart bottle cap sensor according to another embodiment of the present invention.

FIG. 9C is the top view of an exemplary smart cap sensor.

FIGS. 10A-C show data taken from an exemplary implementation of a smart bottle cap sensor of FIGS. 9A-B.

### DETAILED DESCRIPTION OF PREFERRED EMBODIMENTS

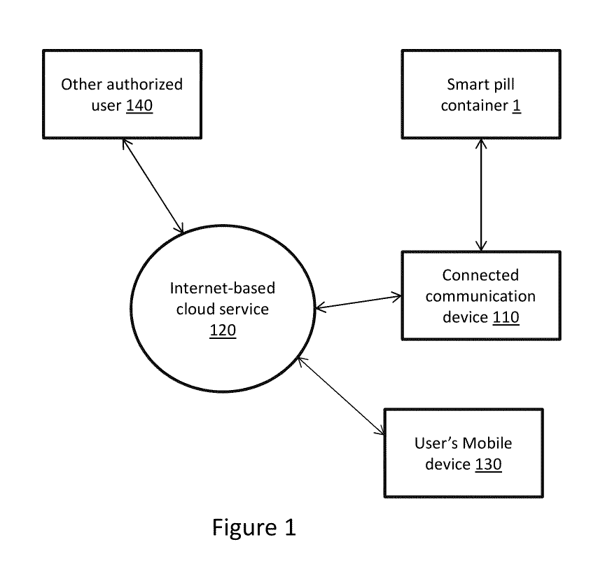

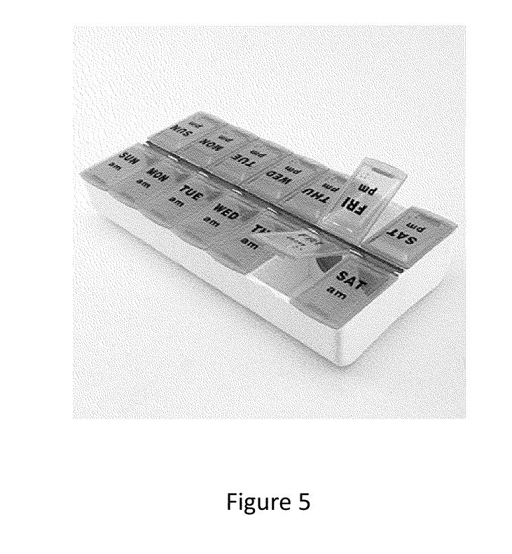

A preferred embodiment of the smart pill box is descripted as follows with reference to FIGS. 1-3B. Like in a conventional pill box (see FIG. 5), the smart pill box 1 has multiple cells 2, which the user uses to help organize daily medicine or medicine needs to be taken at different times. In the smart pill box according to an embodiment of the present invention, the box 1 has sensors to detect if each cell is empty or full with medicine. And the box 1 reports the status (full/empty) to the connected device 110, which may be a smart phone, or a network gateway devices, or a network router, through a wireless connection, which maybe Bluetooth, Wi-Fi, or other wireless links. The status of the pill box can be send, via the connected device 110, to an internet cloud based server 120, running a services software to monitor each user's pill box status. Each user or his care taker, can configure the service software so it will record the status; also it may send out notice (and reminder) to user mobile devices 130, and/or to other authorized person's device 140. The user's mobile device 130 and the connected device 120 in some case can be the same device. The server software can also keep a record of when each user takes medicine in which pill box cell, and provide a summary of how well the user complies with the time schedule that he is required to take the medicine.

The user or the user's authorized care taker can configure the service software to send out different reminders, for example, if the pill box cell has not been emptied at a set time, the service software will send out reminder at certainly time after the time that user is supposed to take the medicine. Also, the user or authorized person can check with service software to get status if the user has taken the medicine or not.

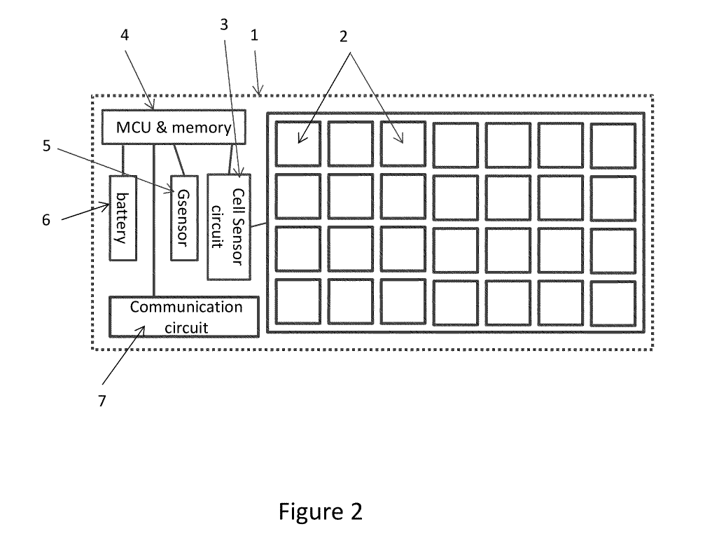

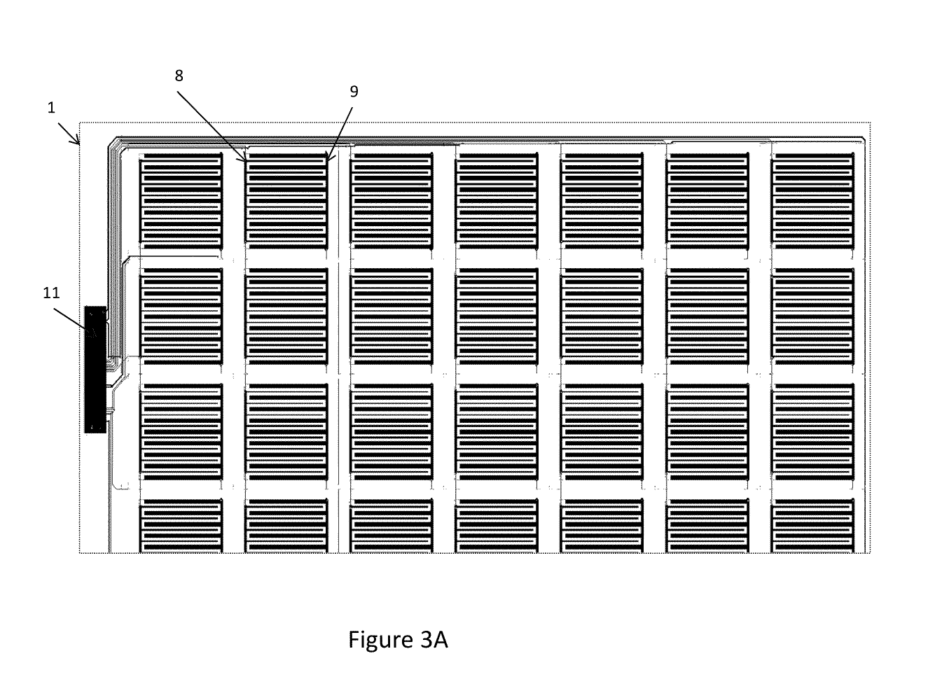

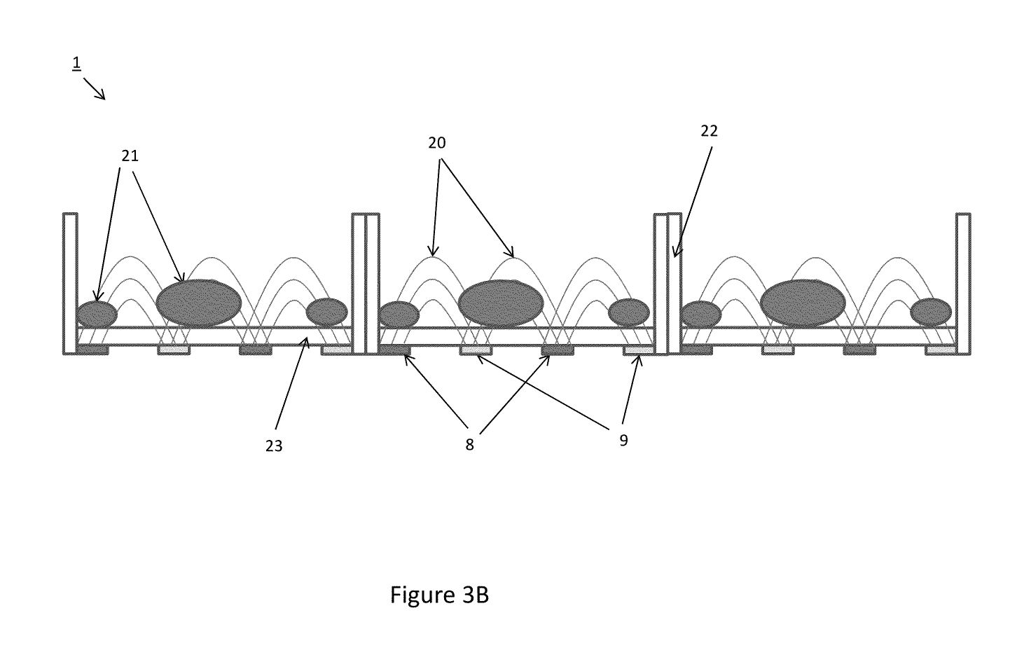

A preferred implementation of the smart pill box 1 of an embodiment of the present invention is illustrated in FIG. 2, where at the bottom of each cell 2, there are capacitive sensor elements. An example implementation of the capacitive sensor elements 8 and 9 is illustrated in FIGS. 3A and 3B. In an example implementation of the smart pill box 1, there is a cell sensor circuit 3, which interfaces with the capacitive sensor elements. The sensor circuit 3 measures the capacitance changes in sensor elements 8 and 9 of each cell. The sensor elements 8 and 9 are designed such that there will be differences in the capacitance between when the cell has pill(s) and when the cell is empty. Alternatively, the sensor elements 8 and 9 and the control circuit 3 may be designed to detect the number of pills present in each cell. The smart pill box 1 also includes a microcontroller (MCU) with memory 4, a wireless communication circuit 7, an accelerometer (G sensor) 5, and a battery 6. The wireless communication circuits 7 can be implement as low energy Bluetooth, Wi-Fi, Zigbee, or some other standard or proprietary wireless communication schemes. The microcontroller 4 can execute a program to control the operation of the various circuits of the smart pill box 1. It also keeps a time and date of when each detected event happens. The events include when the user fills or empties the pill box cells. The microcontroller 4 also stores the status of the pill cells and the event time in the memory. The microcontroller 4 also controls the communication circuit 7 to periodically check if there is a connected communication devices 110 available. A connected communication device can be a cell phone, or a dedicated communication device (like a gateway, a router). When the microcontroller 4 detects a connected communication device available, it transfers the status of the pill box to the connected device, and through the connected device, transfers the status to an internet cloud based service program 120.

The cell sensor circuit 3, the MCU 4, the G sensor 5, the battery 7 and the communication circuit 7 may be physically located at any appropriate location of the overall pill box, such as in a compartment under the cells 2, or in a compartment on the side of the cells, etc.

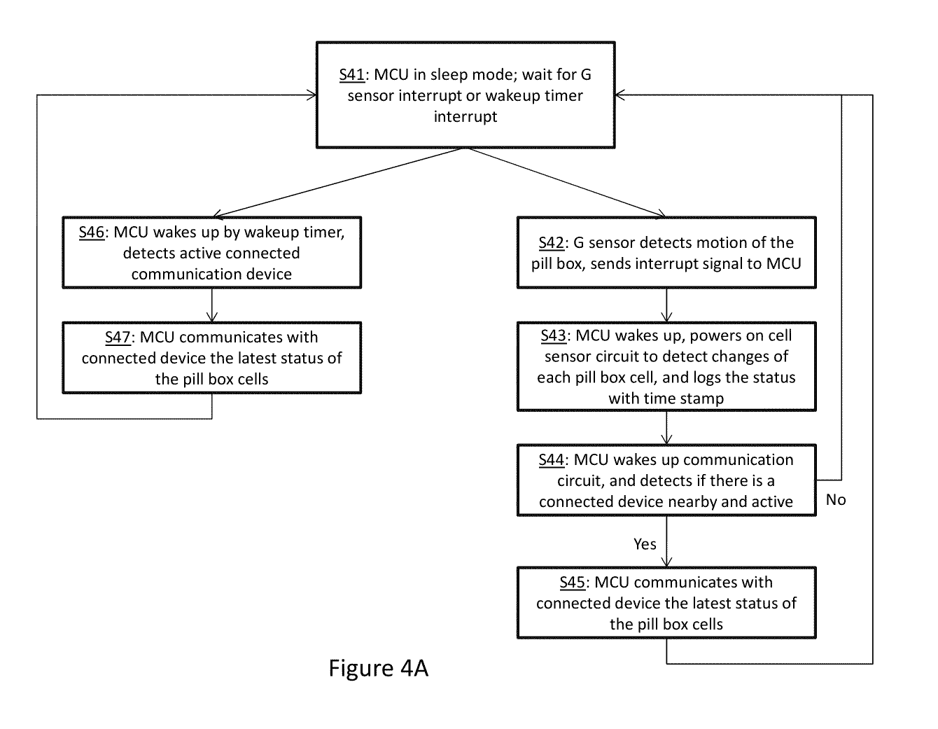

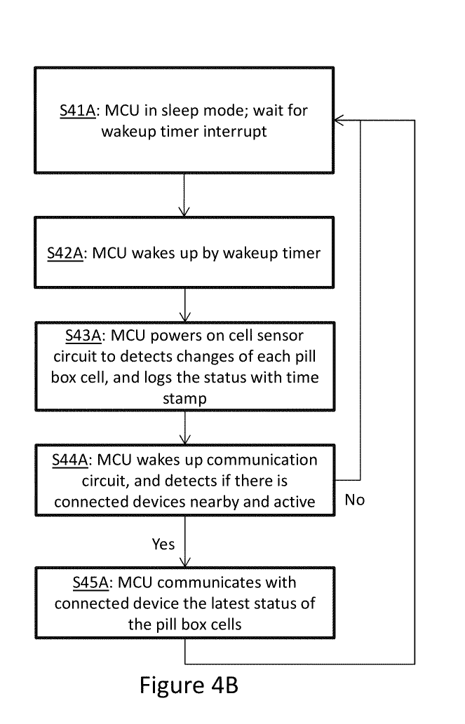

FIG. 4A illustrates a process flow diagram of the smart pill box operation. When the pill box is not in use, the microcontroller 4 puts the system in a low power standby mode (step S41), where, the communication circuit 7 is in a low power standby mode, and the cell sensor circuit 3 is also in a low power standby mode. The G sensor 5 is normally in a low power detection mode, where the G sensor is used to detect if a user is accessing the smart pill box 1. When the user tries to access the smart pill box 1, like he pick up the box to open a cell to get the pill, or fill in the pills, the G sensor detects the motion of the smart pill box (step S42). The G sensor 5 sends a signal to the microcontroller 4 to indicate that the user may be accessing the pill box (step S42). Upon receiving this signal, the microcontroller 4 changes to a normal detection mode; it also turns the sensor circuit 3 to a normal mode, and tries to scan the smart pill box cell sensor elements 8 and 9, to check if there is capacitance changes in each cell 2. And it records the status of the cells in the memory with a time stamp (step S43). The microcontroller 4 also turns the wireless communication circuit 7 into a normal operation mode, and checks for connected device availability (step S44). If the connected device 110 is detected, the microcontroller 4 transfers the status of the smart pill box to the connected device and through the connected device to the internet cloud service program 120 (step S45).

The microcontroller 4 also keeps a counter running in the standby mode, and if the microcontroller has not received signals from the G sensor 5 over a predetermined time period, the microcontroller periodically wakes up the system, and its circuits, to check for connected communication device availability (step S46). When the communication device 110 is available, the microcontroller 4 transfers the recorded status to the connected device 110 and through the connected device transfers it to the internet cloud service program 120 (step S47).

In another simpler form of implementation, illustrated by the flow diagram of FIG. 4B, the G sensor 5 is not required for the pill box system. The microcontroller is normally in a sleep mode and waits for wakeup timer interrupt (step S41A); it wakes up periodically (step S42A), to check the status of the pill box cells (step S43A), and also check for presence of the connected device (step S44A). If the connected device is detected, and the status of the cells has changed, the microcontroller sends updated information to the connected device and through the connected device to the internet cloud based service program (step S44A).

In an exemplary implementation, the capacitive sensing elements for each pill cell are illustrated in FIGS. 3A, 3B. Under each pill cell 2, there are two group of interleaved electrodes 8, 9. One group of the electrodes 8 transmits an RF signals (TX), typically in the frequency range of 100 Hz to 10 MHz. Another group of the electrodes 9 is connected to an amplified receive circuit 11 of sensor circuit block 3, to detect the TX signals. As illustrated in FIG. 3B in detail, the materials 23 form bottom panels of the cells 2 isolates the electrodes from the pills 21, and the cell walls 22 are also provided to contain the pills. These materials forming the bottom panel 23 and cell walls 22 can be plastics, glasses, or other polymers materials which is nonconductive. There is electrical coupling (capacitive coupling) between two group of the electrodes, as schematically indicated by the lines 20, and the present or absent of the pills 21 in the cell changes change the coupling of the signal (i.e. the capacitance between two groups of electrodes changes). The sensor circuit 3 detects these changes, and the software in the MCU 4 receives these data, to determine if the cell status is changed or not.

Two groups of electrodes are used in this example to detect the change of material in the proximity of the electrodes. Similarly one can use a single group of electrode to detect the change of materials in the proximity of the electrode. In that case, there will be just one set of electrode under each pill cell 2.

In another implementation of a smart pill control system, a smart cap sensor is used to monitor the user's opening of the cap of a medicine bottle, and also wirelessly communicate the information to a connected communication device, and through the connected device to an internet cloud service program. Similar to the smart pill box system and method described above, the internet cloud service can provide recording and sending out notifications to user and authorized persons.

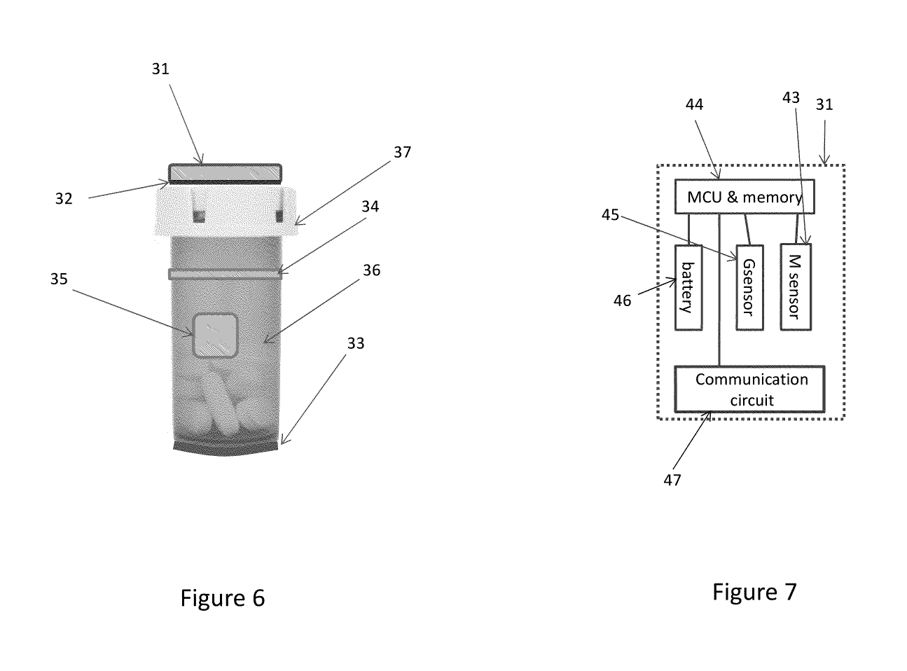

FIGS. 6 and 7 schematically illustrate an implementation of the smart cap sensor used for monitoring the medicine bottle. The sensor unit 31 (also referred to as a detection and communication system) may be attached to the top of the bottle cap 37 by an adhesive 32; the adhesive can be a double sided adhesive tape, or other adhesive. Alternatively, the sensor unit may be located inside the cap, for example, attached to the underside of the cap 37. The sensor unit 31 includes a communication circuits 47, an acceleration sensor (G sensor) 45, a magnetic field sensor (M sensor) 43, a microcontroller and memory 44, and a battery 46. The implementation also includes magnetic materials on the body 36 of the bottle. This can be implemented as a sticker with magnetic properties or a small magnet attached by a sticker, on the side of bottle 35, or on the bottom of the bottle 33, or around the bottle as a ring 34. The electronics detection and communication system 31 may alternatively be located on the body 36 of the bottle, in which case the magnetic material is located on the cap 37.

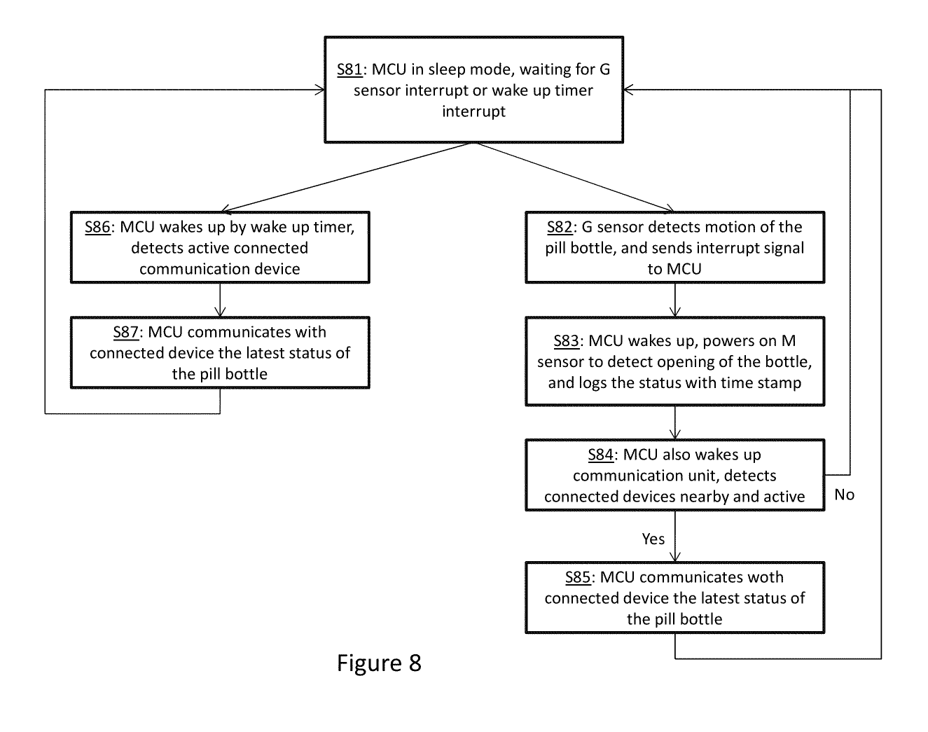

FIG. 8 illustrates a process flow diagram of the smart pill bottle operation. When the pill bottle is not in use, the MCU puts the system in standby mode, where very low power is required (step S81). When the G sensor is in a low power mode, it can detect motions of the bottle. When user picks up the bottle, the G sensor detects the motion, and sends a signal to MCU (step S82); when MCU receives this signal, it wakes up the system, and turn on the M sensor (step S83). When the user opens the cap, the M sensor detects the separation of the M sensor from the magnetic materials on the body of the bottle (33, or 34, or 35). It is the assumption that when user opens the medicine bottle, he will take his pill. The MCU records the event (opening of the bottle cap) with a time stamp. MCU also checks if a connected device is available (step S84), and communicate the event information to connected device and through the connected device, communicate to an internet cloud based service program (step S85). MCU also has an independent wake up timer, which wakes up MCU periodically to check if the connected device is available (step S86), and complete the communication of the bottle event to the connected device and through connected device to an internet cloud based service program (step S87). The cloud based service program 120 can record the event, and perform statistics of the event, and generate report of user/bottle use, and send out notices to user and other authorized persons. In the event that the user forgot to take pill, the service program sends out reminder to user and other care taker.

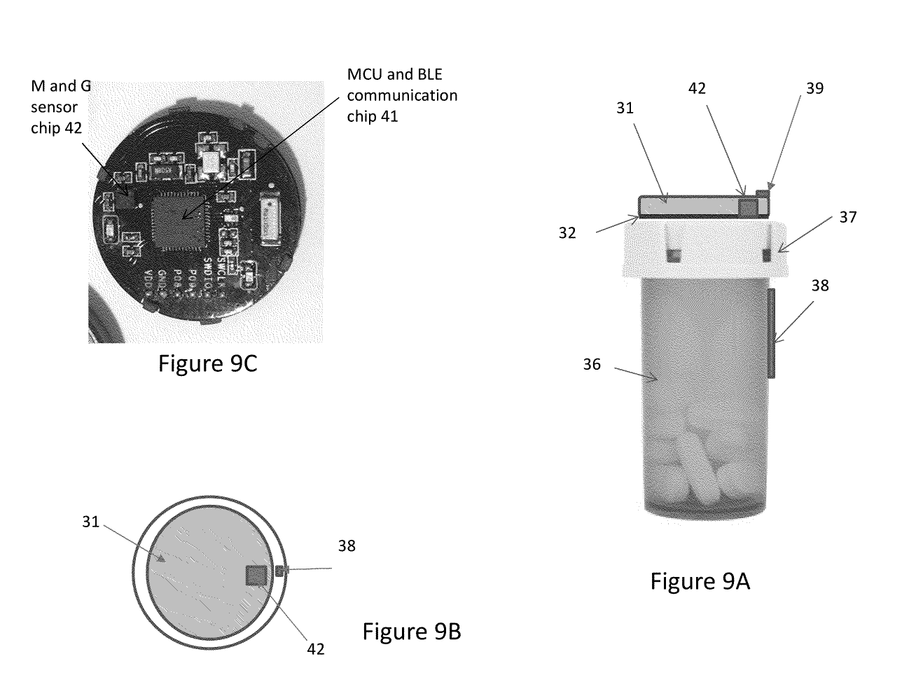

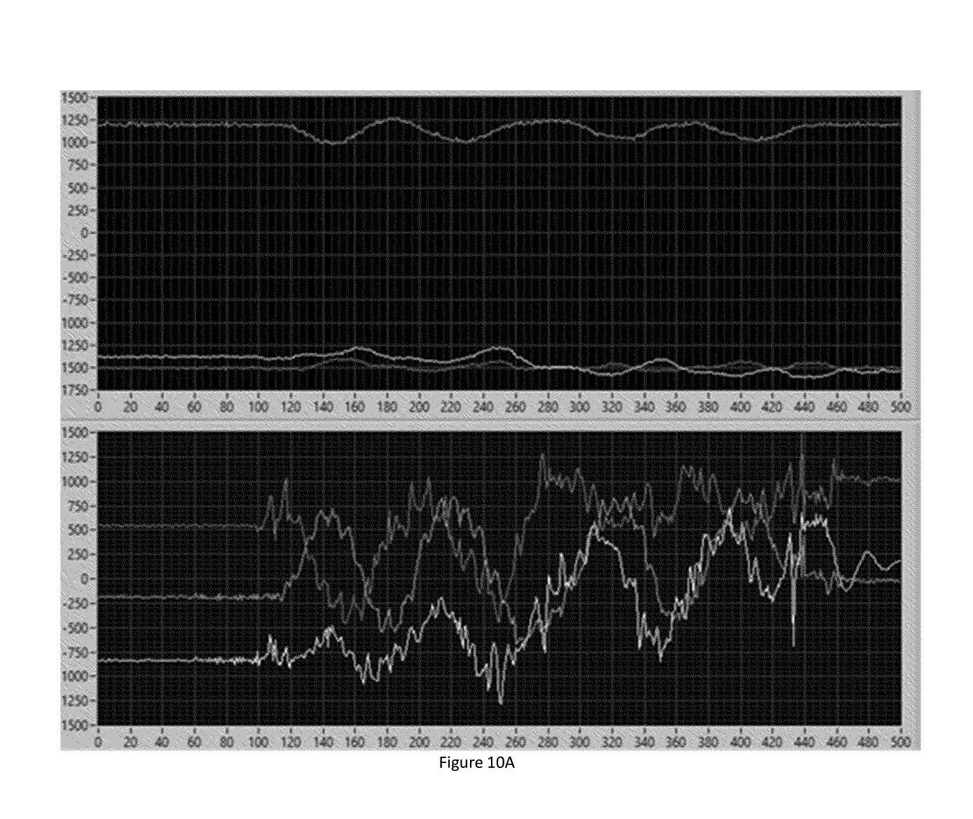

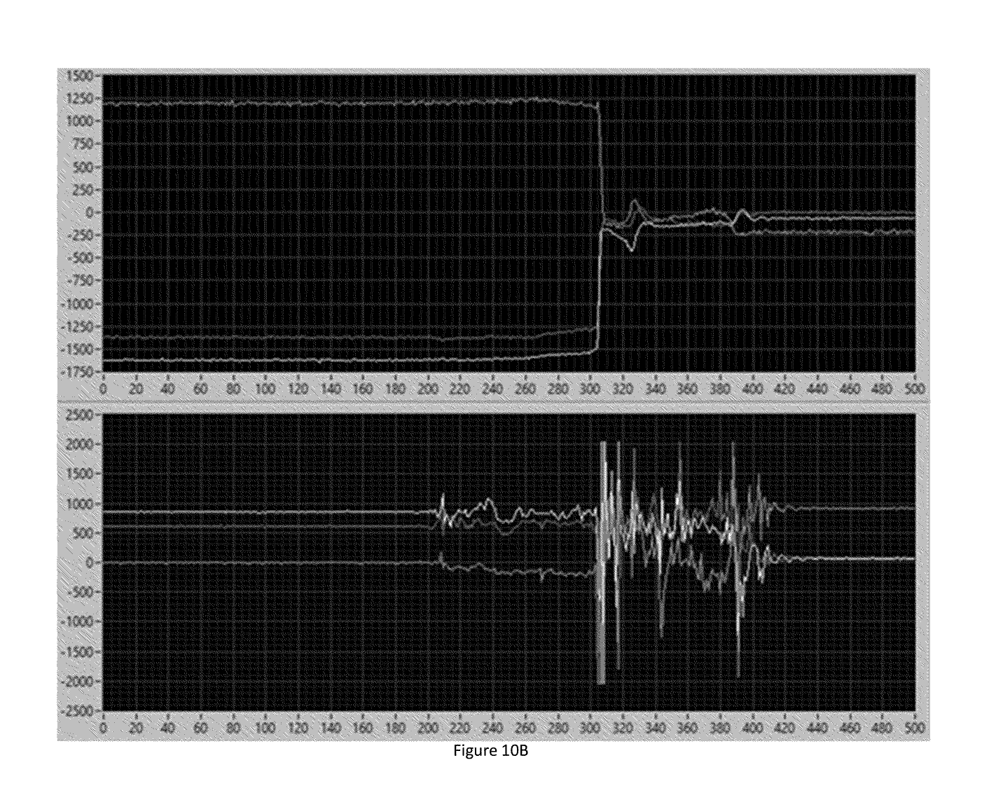

FIGS. 9A and 9B schematically illustrate another implementation of this embodiment. FIG. 9A is side view and FIG. 9B is a top view of the medicine bottle. In this implementation, the detection and communication system 31 is located in the bottle cap 37; it includes a chip 42 which includes a magnetic field sensor (M sensor) or both an acceleration sensor (G sensor) and an M sensor (a combination chip), and a chip 41 that integrates the MCU 44 and the communication circuit 47. FIG. 9C is a photograph showing a sample detection and communication system 31 including the chips 41 and 42 (M and G sensor chip). A magnetic material strip 38 is mounted on the body 36 of the medicine bottle, where the north and south poles of the magnet 38 is aligned in up/down direction (i.e. in the longitudinal direction) of the body 36 to ensure maximum magnetic field spread out of the magnet to reach the M sensor. The relative location of the M sensor and magnet strip is to be kept as close as possible to maximum the signals of the magnet on the M sensor. As shown in FIG. 9B, in the top view, the magnetic strip 38 and the M (or M and G) sensor chip 42 are aligned in the circumferential direction when the cap 37 is properly closed on the body 36 of the bottle. The magnet strip 38 can be attached with an adhesive tape to the side of the bottle.

A visible marker 39 is optionally provided on the outside of the sensor unit 31 to indicate the position of the M sensor 42 inside the sensor unit. It helps the user to place the magnet strip 38 close to the M sensor. If the G sensor is in a separate chip from the M sensor, then the location of the G sensor is not important, as long as it is mounted inside the sensor unit 31. The chips are preferably mounted on a printed circuit board. Note that the M and G sensors in the sensor chips have their built in directionality, typically including three axes; when the chips are mounted on the PCB, the alignment of the axes depend on the PCB mount. In most applications the precise directions of the axes are not important.

The G sensor can detect movements of the bottle, while the M sensor can detect the rotation of the cap 37 or its removal from the body 36. In actual implementations, for a given G and M sensor chip 42 and a given magnetic strip 38 on a given bottle, the signal from the G and M sensor relative to the remove of the cap 37 of the bottle can be measured; based on the measurements, the microcontroller is designed to have appropriate signal thresholds for making various determinations as to whether the bottle is being picked up or the cap is being removed.

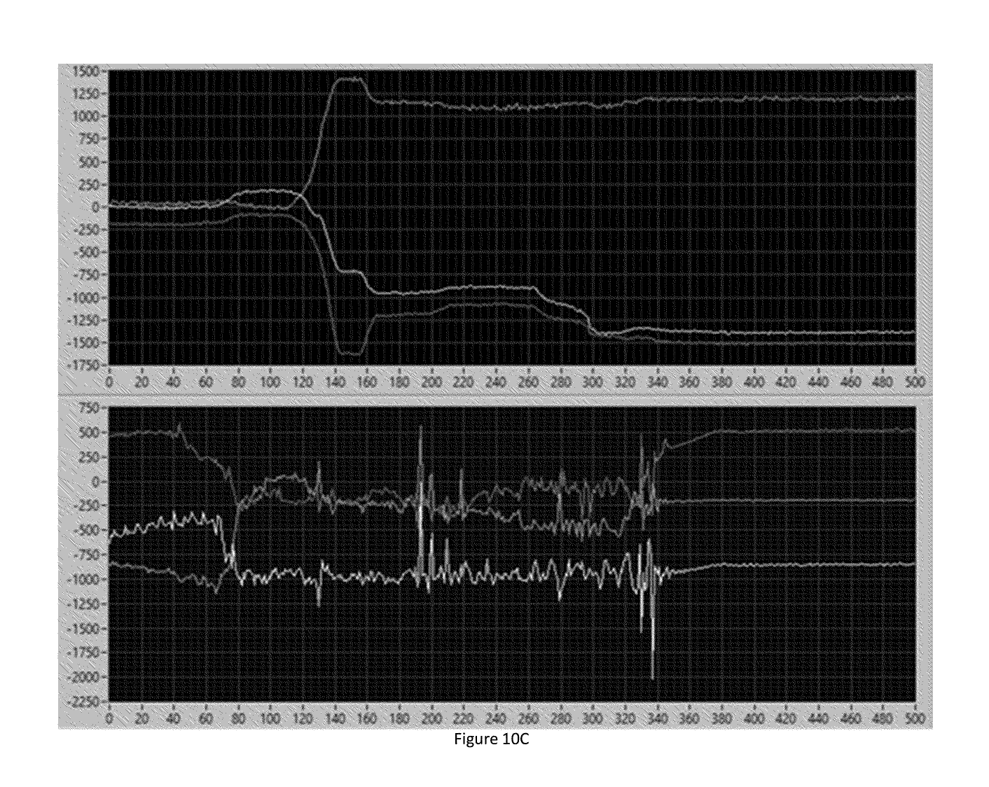

FIGS. 10A-C are examples of measurement data taken from a smart cap sensor having the configuration of FIGS. 9A-B. In each figure, the top panel is the M sensor signal and the bottom panel is the G sensor signal. Each sensor has three axels and their signals are represented by the three curves. In FIG. 10A, where the vertical axis is the signal of the sensor output, and the horizontal axis is the samples read in by the MCU, typical in the time of 1 Hz to 10 kHz sample rate, this graph is sample at 10 Hz rate, the cap was on the bottle body and the bottle was moved. In this case, when the bottle was moved, the G sensor signal changed up to +/−500 units, while the M sensor signal changed by smaller amounts, about +/−200 units, which are similar to the signal caused by changes in the earth magnetic field. In other words, and M sensor was picking up the changes in the magnetic field by moving the bottle in in the earth's magnetic field.

In FIG. 10B, the bottle cap was removed. It can be seen that the M sensor signal changed more than 1000 units in all 3 directions, which is much larger than the signal caused by changes in the earth's magnetic field in FIG. 10A. Also, the signal in one direction was of the opposite polarity as that in the other two directions. The G sensor signal also picked up the motion of the cap.

In FIG. 10C, the bottle cap was put back on, where the magnetic strip on the bottle was again aligned with the M sensor. It can be seen that the G sensor picked up the motion of the cap (the signal change is +/−200 units). The M sensor signal again changed over 1000 units in all 3 directions; again the signal in one direction is of the opposite polarity as that in the other two directions. The M sensor signal change back to the state it was in when the cap was close on the bottle. The data shown in FIGS. 10A-C demonstrates that the movement of the bottle and the removal and re-placement of the cap can be reliably detected using the M and G sensors in the present embodiments.

In another implementation, every time when user closed the cap put the bottle back to storage, user can shake the bottle, or hit gently table two or more times. This can signal the sensor through the signal of the G sensor that the bottle is closed put to rest. And the sensor can ran through a calibration program to acquire the normal values of each sensor as baseline values. These baseline values can be used to compare with sensor values when user pick up the bottle and remove the cap. This makes it more accurate to determine the thresholds to determine the state changes of the bottles.

This smart cap implementation can also be used to monitor access of a bottle for other materials. For example, it can be used to monitor alcohol bottles, so if the bottle is open by unknown person, it will send notice to internet service program. This can monitor unwanted kids use of alcohol in the family. It can also be used in the hotel to monitor the access of the premier drinks provide in hotel room.

It will be apparent to those skilled in the art that various modification and variations can be made in the smart medicine container and related method of the present invention without departing from the spirit or scope of the invention. Thus, it is intended that the present invention cover modifications and variations that come within the scope of the appended claims and their equivalents.

What is claimed is:

1. A smart pill box system comprising:
a pill box body with multiple cell for containing pills;
a sensor on the bottom of each cell for detecting presence or absence of the pills in the cell;
a sensor circuit for processing signals from the sensor;
a communication circuit for wireless communication with external devices;
a battery; and
a microprocessor unit and memory for controlling operations of the sensor circuit and communication circuit.

2. The smart pill box system of claim 1, wherein the sensor is a capacitive sensor for generating capacitance signals in response to the presence or absence of the pills.

3. The smart pill box system of claim 2, further comprising an accelerometer for detecting motions of the smart pill box.

4. A method for monitoring the status of a smart pill box, the smart pill box comprising one or more cells for containing pills, a sensor system for detecting presence or absence status of pills in each cell, control circuitry, and a communication unit, the method comprising:
detecting the presence of absence status of each cell using the sensor system;
recording status information for each cell using the control circuitry; and
communicating the status information wirelessly to an external data processing system using the communication unit.

5. The method of claim 4, wherein the smart pill box further comprises an accelerometer for detecting motions of the smart pill box, the method further comprising generating a wakeup signal for the control circuitry when a motion of the smart pill box is detected.

6. A smart pill bottle system comprising:
a sensor unit on the bottle, which includes an accelerometer, a magnetic field sensor, a communication circuit, a battery and a microcontroller and memory; and
a magnetic material placed on the bottle,
wherein the sensor unit is located on a cap of the bottle and the magnetic material is located on a body of the bottle, or the sensor unit is located on the body of the bottle and the magnetic material is located on the cap of the bottle.

7. A method for monitoring a smart pill bottle, the smart pill bottle including a sensor unit which includes an accelerometer, a magnetic field sensor, a communication circuit, a battery and a Microcontroller and memory, and magnetic material, wherein the sensor unit is located on a cap of the bottle and the magnetic material is located on a body of the bottle, or the sensor unit is located on the body of the bottle and the magnetic material is located on the cap of the bottle, the method comprising:
detecting a motion of the pill bottle using the accelerometer and generating a wakeup signal for the microcontroller;
detecting an event of a separation of the cap and the body of the bottle using the magnetic field sensor and the magnetic material and recording the separation event; and
communicating the separation event to an external device.
